(19) United States
(12) Patent Application Publication
(10) Pub. No.: US 2016/0187143 A1
(43) Pub. Date: Jun. 30, 2016

(54) MECHANISM FOR FACILITATING DYNAMIC LOCATION-BASED ZONE MANAGEMENT FOR COMPUTING SYSTEMS

(71) Applicants: Robert COLBY, Granite Bay, CA (US); Xiaoyong PAN, Shanghai (CN); Justin LIPMAN, Shanghai (CN); Jiang YONG, Shanghai (CN)

(72) Inventors: Robert COLBY, Granite Bay, CA (US); Xiaoyong PAN, Shanghai (CN); Justin LIPMAN, Shanghai (CN); Jiang YONG, Shanghai (CN)

(21) Appl. No.: 14/129,919

(22) PCT Filed: Sep. 2, 2013
(86) PCT No.: PCT/CN2013/082785

§ 371 Date: Aug. 20, 2014

(51) Int. Cl. G01C 21/20; G01C 21/26

(52) U.S. Cl. CPC G01C 21/20; G01C 21/26; G01C 21/206

(57) ABSTRACT

A mechanism is described for facilitating location-based zone management for computing systems according to one embodiment. A method of embodiments, as described herein, includes receiving, at a server computing device, a request to locate a destination relating to an entity, retrieving a first data relating to an outdoor navigation portion of an address relating to the destination, and retrieving a second data relating to an indoor navigation portion of the address relating to the destination. The first and second data are retrieved from a first database coupled with the first server computing device. The method may further include communicating the first data and the second data to a client computing device.

### FIELD

Embodiments described herein generally relate to global positioning. More particularly, embodiments relate to a mechanism for facilitating dynamic location-based zone management for computing systems.

### BACKGROUND

The last mile is a well-known and notoriously difficult problem. For Location-Based Services (LBS), it is no different. Today, when searching for directions, a user typically enters an address into a location engine (such as a Global Positioning System (GPS)-based device) and the turn-by-turn directions provided by the location engine can get the user to the street address, but not to the final location (e.g., parking spot, doctor's office, campus building, etc.). Another problem is that there is no way to effectively communicate any changes at the physical location (e.g., an entrance that is available during the day might not be available at night or local construction hurdles, etc.) to the user.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a dynamic location-based zone management mechanism employed at a computing device according to one embodiment.

FIG. 2 illustrates a dynamic location-based zone management mechanism according to one embodiment.

FIG. 3A illustrates a method for facilitating dynamic location-based zone management for computing systems according to one embodiment.

FIG. 3B illustrates a transaction sequence for facilitating dynamic location-based zone management for computing systems according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a dynamic location-based zone management of data for facilitating location-based global positioning of computing devices. In one embodiment, a central zone registry service may be established to enable individuals and/or entities to register and even locally manage a specific geodetic zone within their own infrastructure. An entity may refer to anyone having an address, such as a business, a company, an educational institution, a non-profit entity, a government agency, a political office, etc. It is to be noted that terms like “entity”, “organization”, “group”, “agency”, “institution”, or the like, may be interchangeably used throughout this document. In some embodiments, an entity may include or refer to an individual having a business address and/or a personal address (e.g., primary home address, secondary home address, etc.).

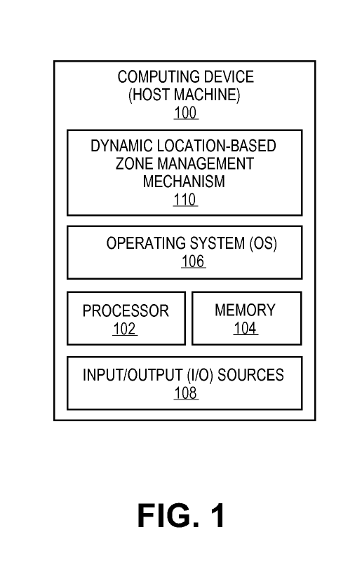

FIG. 1 illustrates a dynamic location-based zone management mechanism 110 employed at a computing device 100 according to one embodiment. Computing device 100 serves as a host machine for employing dynamic location-based zone management mechanism (“zone mechanism”) 110 for facilitating dynamic location-based zone management for computing systems. Computing device 100 may include mobile computing devices, such as cellular phones including smartphones (e.g., iPhone® by Apple®, BlackBerry® by Research in Motion®, etc.), personal digital assistants (PDAs), etc., tablet computers (e.g., iPad® by Apple®, Galaxy 3® by Samsung®, etc.), laptop computers (e.g., notebook, netbook, Ultrabook™, etc.), e-readers (e.g., Kindle® by Amazon®, Nook® by Barnes and Nobles®, etc.), etc. Computing device 100 may further include set-top boxes (e.g., Internet-based cable television set-top boxes, etc.), and larger computing devices, such as desktop computers, server computers, etc.

Computing device 100 includes an operating system (OS) 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “computing device”, “node”, “computing node”, “host”, “server”, “memory server”, “machine”, “device”, “computing device”, “computer”, “computing system”, and the like, may be used interchangeably throughout this document.

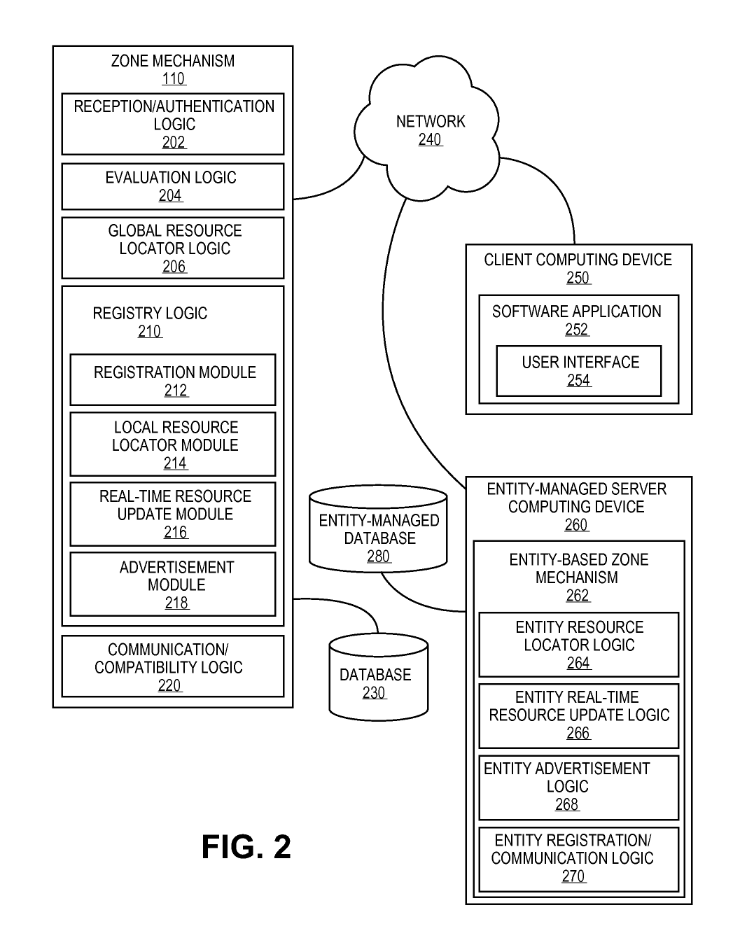

FIG. 2 illustrates a dynamic location-based zone management mechanism 110 according to one embodiment. In one embodiment, zone mechanism 110 may include a number of components, such as: reception/authentication logic 202; evaluation logic 204; global resource locator logic 206; registry logic 210 including registration module 212, local resource locator module 214, real-time resource update module 216, advertisement module 218; and communication/compatibility logic 220. Further, zone mechanism 110 may be coupled with one or more databases, such as database 230 having global resource data, local resource data, registry data, advertisement data, client data, entity data, etc. Zone mechanism 110 may be hosted by a LBS server computing device, such as host machine 100 (also referred to as “geo registry server”, “registry server”, “host server”, “geo registry”, “geo registry server”, and “public space server”) of FIG. 1, and may be in communication with any number and type of other computing systems, such as user-accessible computing device 250 (e.g., client computing device) and entity-managed computing device 260 (e.g., server computing device) over one or more networks, such as network 240 (e.g., cloud network, the Internet, etc.). Entity-managed computing device 260 may also be referred to as “entity-managed server”, “site-managed server”, “owner-managed server”, “organization-managed server”, “site geo server”, “site owner's geo server”, and “private space server”.

In one embodiment, entity-based zone mechanism 262 may also include a number of components, such as entity resource locator logic 264, entity real-time resource update logic 266, entity advertisement logic 268, and entity registration/communication logic 270. Further, entity-based zone management mechanism may be in communication with one or more entity-managed databases, such as database 280 having local resource data, advertisement data, etc. Although zone and entity-based zone mechanisms 110, 262 will be subsequently discussed in this document in terms of their corresponding tasks, it is contemplated that any number and type of tasks may be swapped between zone mechanism 110 and entity-based zone mechanism 262, such as a business' detailed/localized physical address may be retrieved by zone mechanism 110 from the local resource data at database 230 and communicated to client computing device 250 without having to outsource the task to entity-based zone mechanism 262. Throughout this document, “logic” may be interchangeably referred to as “component” or “module” and may include, by way of example, software, hardware, and/or any combination of software and hardware, such as firmware.

In one embodiment, an entity/organization associated with entity-based zone mechanism 262 may choose to opt-in and register with zone mechanism 110 to allow zone mechanism 110 to manage its LBS (e.g., physical location/address), promote advertisement, etc. To register, the entity may send a request to zone mechanism 110 which receives and authenticates the request at reception/authentication logic 202. The request may be authenticated using any number of techniques, such as by verifying the entity's unique identification, matching entity information against information on file, etc. Upon receiving and authenticating the request, the request may be sent to registration module 212 at registry logic 210 for further processing. At registration module 212, the entity is formally registered while the registry and other relevant data (“resource data”) (e.g., physical addresses, services and/or products, calendars/schedules, etc.) about the entity may be stored at database 230. Upon registering the entity, in one embodiment, zone management 110 may manage the entity's location information, advertisement promotions, etc., while, in another embodiment, zone management 110 may outsource any number and types of tasks to be performed directly at site by entity-based zone management 262, allowing entities (e.g., vendors, customers, businesses) to directly manage their own LDS, etc., in an open architecture framework.

Once the registration is performed, any amount of resource data may be shared between zone mechanism 110 and entity-based zone mechanism 262 and stored at their corresponding databases 230, 280. For example, a user (e.g., medical patient) accesses client computing device 250 (e.g., mobile computing device, such as smartphone, tablet computer, GPS device, etc.) to request LBS information about a specific location (e.g., directions to his doctor's office at a local medical complex). The user may enter a request (such as using geotag, geocode, etc.) in computing device 250 via user interface 254 provided by software application (e.g., website (e.g., Google Maps, MapQuest®, etc.), GPS software application, etc.). The request is received and authorized at reception/authentication logic 202. The request may then be parsed and evaluated for processing by evaluation logic 204, such as whether the information requested can be retrieved from database 230, etc. In one embodiment, the request may include contents providing a destination name, a street address, a more detailed address including the exact location of the destination, other identifiers, such as coordinates (e.g., longitude, latitude, altitude, etc.), a goetag, a geocode, etc., or a combination thereof. Such contents are then parsed or broken down, evaluated to determine the next process, translated (e.g., coordinates are translated into a physical address or vice versa, etc.), and/or used to perform searches (e.g., an address may be used to search best/available entrance to a building complex, check on traffic status in the area, find mobile devices or other computers or printers, etc., in the area), etc., by evaluation logic 204.

The term “geotag” refers to a process of “geotagging” which includes adding geographical identification metadata to various data (e.g., media, such as video, photographs, websites, text messages, etc.) that typically includes coordinates relating to altitude, longitude, latitude, distance, physical location, bearing or compass/navigation, etc. Further, geotagging-related data may be used to search for various resources, such as location-based websites, news, etc. The term “geocode” refers to a process of geotagging to help users find a variety of location-specific information, such as finding an activity performed near or at a given physical location by simply entering its coordinates, such as latitude and longitude coordinates, into a search engine. Further, geocoding, along with geotagging, may be used for taking non-coordinate based geographical identifiers, such as street address, to find their corresponding geographic coordinates or vice versa provide alternative search techniques

Continuing with example, upon evaluation, the requested is forwarded on to global resource locator logic 206 to retrieve the necessary information from database 230. In one embodiment, the entire address requested by the user may be retrieved from database 230 and communicated, via communication/compatibility logic 220, to client computing device 250 where the address is displayed to the user via user interface 254. For example, upon having global resource locator logic 206 gather a first portion of the requested address, such as the street address portion (e.g., ABC Medical Complex, 123 Main Street, Santa Monica, Calif. 90405) of the requested address, the request may be forwarded on to local resource locator module 214 at registry logic 210 to retrieve a second portion of the requested address and any relevant information that is specific to the directions to the doctor's office requested by the user. For example, the second portion of the requested address may include the rest of the address (e.g., office location, building location, parking space, best/available entrance to the medical complex, etc.) and any other relevant information (e.g., nearby construction or other obstacles, traffic status, etc.), etc.

In another embodiment, the first portion of the requested address may be retrieved from database 230 by global resource locator logic 206, but the second portion of the requested address may be obtained directly and locally from entity-based zone mechanism 262. In this case, upon obtaining the first portion of the street address, zone mechanism 110 direct client computing device 250 to entity-based zone mechanism 262; for example, zone mechanism 110 may reply to client computing device 250 with an internet protocol (IP) address of entity-managed server computing device 260, where the IP address may then be used by client computing device 250 to redirect to entity-managed server computing device 260. Once the redirection is completed, entity resource locator logic 264 may retrieve the second portion of the requested address from entity-managed database 280. Once the second portion is gathered, the first and the second portions of the requested address are provided to the user via client computing device 250.

Referring back to the second portion, it guides the user to the specific location (such as by indoor navigation) as requested by the user. Typically, most GPS devices stop at providing the first portion, such as the street address. In one embodiment, once the user is reached the street, using the second portion of the requested address, he may be guided to the best/available entrance to the medical complex (e.g., based on the proximity to the doctor's office, daily entrance hours, traffic situation in the area, parking availability, etc.), the parking lot/spot (e.g., based on its proximity to the doctor's office, etc.), the exact office building (e.g., building A) and then on to the indoor navigation, such as the exact floor (e.g., third floor) and the office (e.g., office A-300).

Furthermore, in one embodiment, the location information may be dynamically updated based on any incoming relevant information from any number of sources. For example, an individual passerby, a person (e.g., employee, etc.) associated with the entity, any person who is specifically assigned the responsibility to provide the relevant information, etc., may provide relevant information to the entity, such as in-person, by calling the entity, via the entity website, etc.), which can then be used to update the existing information. For example, a driver may report a traffic accident or a protest on the street, etc., which may then be used by real-time resource update module 216 and entity real-time resource update logic 266 to update, in real-time, the information at database 230 and entity-managed database 280, respectively. Similarly, continuing with the example above, in case of a change of location (e.g., office location, building location, street location, etc.), office hours, etc., the information at database 280 may be locally updated by the entity staff which may then be automatically communicated to zone mechanism 110 to update database 230. Given the updates are performed in real-time, if any portion of the information is updated during communication of the requested address to the user, the requested address may be dynamically altered to provide the user the most recent and accurate information.

In one embodiment, each request may be divided in to the aforementioned first and second portions. Although some information/data between the two portions may overlap, the first portion may include data relating to outdoor navigation (e.g., navigation up to a street address leading to a park, a stadium, a campus, an airport, a beach, a hotel, a cinema/theater, a library, a parking lot, a building, an office, a house, etc.) while the second portion may include data relating to indoor navigation or beyond the street address (e.g., navigation within a park, a stadium, a campus, an airport, a hotel, a cinema/theater, a library, a parking lot, a building, an office, a house, etc.).

As previously mentioned, it is contemplated that an entity is not limited to an organization or a business and it may include an individual who chooses to manage server computing device 260 to provide accurate and door-to-door directions to a business address (e.g., hotel, office building, etc.) which may occasionally change (e.g., the individual is a freelance photographer or a traveling salesperson, etc.), a primary home (which may be, for example, an apartment in a difficult-to-navigate apartment complex, etc.), a secondary home (which may be, for example, nested deep into the woods, etc.), etc.

It is further contemplated that embodiments are not limited to navigating any particular geographic location (e.g., a particular city or even a country, etc.) or any particular form of indoor/outdoor navigation (such as to find an office in a building complex, a store in a shopping mall, etc.), but that other forms of indoor/outdoor navigations may also be performed that do not necessarily require a user to be present at the destination (e.g., without requiring the user to walk, drive, fly, etc., to the destination). For example, a user (e.g., student), in the United States of America (USA), may wish to print a document for a colleague at a school in another country (e.g., France). Using client computing device 250 in the USA, the user may enter the zone/location information relating to a zone or location that is near or preferably within the school to find a printer that is closest to her colleague in France. Upon entering the zone/location information, zone mechanism 110 may perform various tasks and redirect client computing device 250 to entity-managed server computing device 260 which, in this example, may belong to and be managed by the school, the entity, and located in France. Having received the request for a printer, entity-based zone mechanism 262 may provide the user with names and locations of any number and types of printer located near the colleague (e.g., on the same floor, in the same building, in the next building, etc.). Upon receiving that information, the user may choose to print the document at a printer closest to the colleague and notify the colleague.

In one embodiment, advertisement module 218 and entity advertisement logic 268 are employed to use the location information for advertisement or broadcast/publication purposes. For example, a business (e.g., Starbucks®, etc.) may register its store locations with registry logic 210 at zone mechanism 110 and then publically advertise its stores to all potential and existing customers while providing door-to-door directions (as opposed to simply offering street address or mall/shopping center directions) to its stores. In one embodiment, an advertisement may be offered to a user at client computing device 260 either directly through entity advertisement logic 268 or via advertisement module 218 having retrieved location information from database 230 and entity-managed database 280, respectively.

Communication/compatibility logic 220 may be used to facilitate dynamic communication and compatibility between various computing device, such as host machine 100 of FIG. 1, user-accessible client computing device 250 (e.g., mobile computing device), entity-managed server computing device 260, etc., databases, such as database 230 and entity-managed database 280, and networks, such as network 240 (e.g., Internet, cloud-computing network, etc.), websites, (e.g., social networking websites, such as Facebook®, LinkedIn®, Google+®, etc.), etc., while ensuring compatibility with changing technologies, parameters, protocols, standards, etc.

It is contemplated that any number and type of components may be added to and/or removed from zone mechanisms 110, 262 to facilitate various embodiments including adding, removing, and/or enhancing certain features. For brevity, clarity, and ease of understanding of zone mechanisms 110, 262 many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

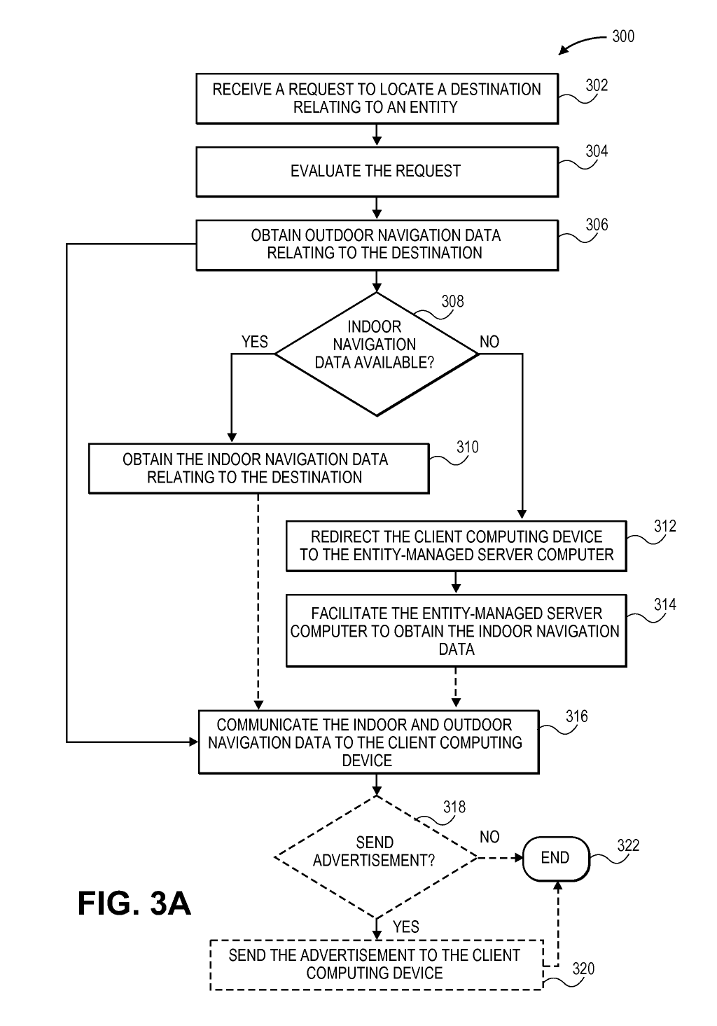

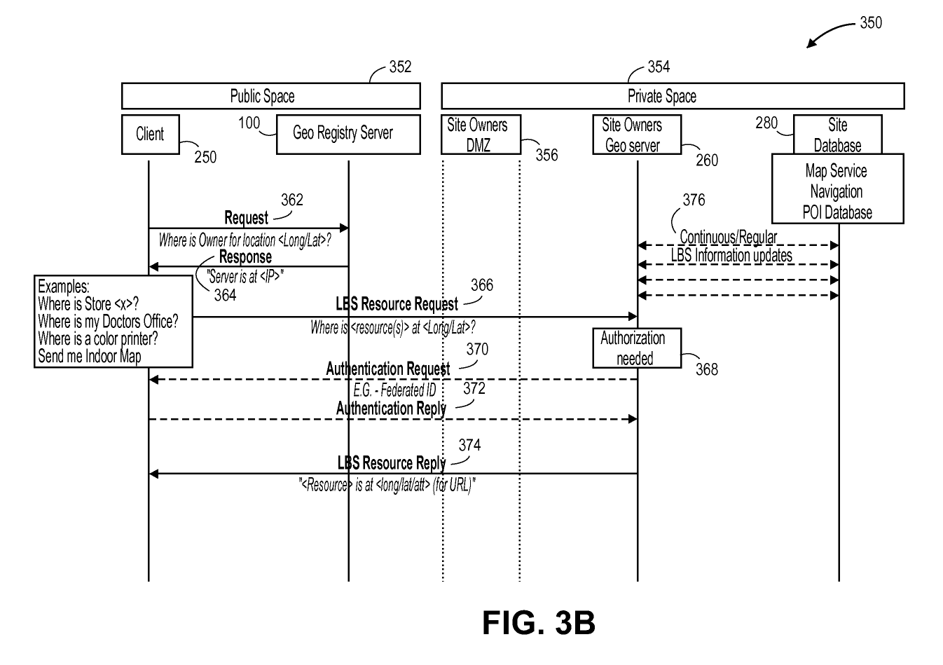

FIG. 3A illustrates a method 300 for facilitating dynamic location-based zone management for computing systems according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by zone mechanism 110 and/or entity-based zone mechanism 262 of FIG. 2.

Method 300 begins at block 302 with receiving, at a registry server, a request from a user-accessible client computing device. The request relates to seeking, in real-time, an accurate and updated door-to-door address leading to a destination (e.g., a park, an office, a building, a parking lot, a house, a smartphone, a printer, etc.) relating to an entity that is registered with the registry server. The entity (e.g., a business, an educational institution, a government agency, an individual, etc.), via an entity-managed server, may have already registered itself with the registry server to allow the registry server the responsibility to perform indoor/outdoor navigations, assume from the registry server the responsibility to perform indoor/outdoor navigations, allow to or assume from the registry server advertisement responsibilities, etc. At block 304, the received request is evaluated. The evaluation of the request may include parsing contents of the request, evaluating or analyzing the contents to determine the future processing path, translating some or all of the contents from one form to another (e.g., street address to coordinates or vice versa), using some or all of the contents to perform searches, etc.

At block 306, a process is initiated by the registry server to retrieve any outdoor navigation data relating to the requested destination from a registry database associated with the registry server. At block 308, a determination is made as to whether the registry database contains any relevant indoor navigation data and the registry server is allowed to obtain and provide the indoor navigation to the client computing device and if yes, at block 310, the registry server retrieves the indoor navigation data from the registry database. If not, at block 312, the client device is (re)directed to the entity-managed server (e.g., using the IP address of the entity-managed server) for further processing of the request. At block 314, the entity-managed server is facilitated by the registry server to retrieve the relevant indoor navigation data from an entity-managed database associated with the entity-managed server.

At block 316, the indoor and outdoor navigation data is forwarded to the client computing device for the user to access, view and use via a user interface at the client computing device. In one embodiment, the indoor and outdoor navigation data is provided to the client computing device by the registry server. In another embodiment, the outdoor navigation data is provided to the client computing device by the registry server, but the indoor navigation data is provided to the client computing device by the entity-managed server.

At block 318, a determination is made as to whether any the user may receive an advertisement broadcast relating to the requested destination or other destinations relating to the entity. If yes, at block 320, the relevant advertisement is forwarded to the client computing device by, in one embodiment, the registry server or, in another embodiment, the entity-managed server, and if not, the process ends at block 322. It is contemplated that the processes of blocks 318 and 320 are optional as, for example, the entity-managed may not have opt-in to register for the advertisement option or may to choose to send the advertisement to this particular user and/or at this particular time, etc.

FIG. 3B illustrates a transaction sequence 350 for facilitating dynamic location-based zone management for computing systems according to one embodiment. Transaction sequence 300 may be performed by processing logic that may comprise hardware (e.g., circuitry, dedicated logic, programmable logic, etc.), software (such as instructions run on a processing device), or a combination thereof. In one embodiment, transaction sequence 350 may be performed by zone mechanism 110 and/or entity-based zone mechanism 262 of FIG. 2.

In the illustrated embodiment, the space is divided into public space 352 and private space 354, where user, using client computing device 250 (e.g., smartphone, tablet computer, etc.), places a request 362 (e.g., direct to site owner's server 260 associated with a destination/location (by longitude/latitude coordinates)) of with host machine or registry server computing device 100. In one embodiment, registry server 100 may respond 364 by redirecting client computing device 250 to entity-managed server or site owner's geo server 260 for further processing of the request. Upon redirection, the LBS resource request (e.g., “where is the store?”, “where is my doctor's office?”, “where is the color printer?”, “send me an indoor map of a performing arts complex”, etc.) is forwarded 366 on to entity-managed server 260.

Upon receiving the request, a determination is made as to whether (further) authentication is needed 368. If not, the authentication processed is skipped and an LBS resource reply (e.g., exact location of or navigation to the requested destination) is sent 374 to client computing device 250. If authentication is required, an authentication request is sent 370 from entity-managed server 260 to client computing device 250. In return, an authentication reply is received at entity-managed server 260 from client computing device 250. Upon successful authentication, the LBS resource reply is sent 374 to client computing device 250. In one embodiment, data at entity-managed database 280 is available for retrieval by entity-managed server 260 and is continuously revised and updated 376, in real-time, at entity-managed database 280 using, for example, entity resource update logic 266 of entity-managed zone mechanism 262 of FIG. 2.

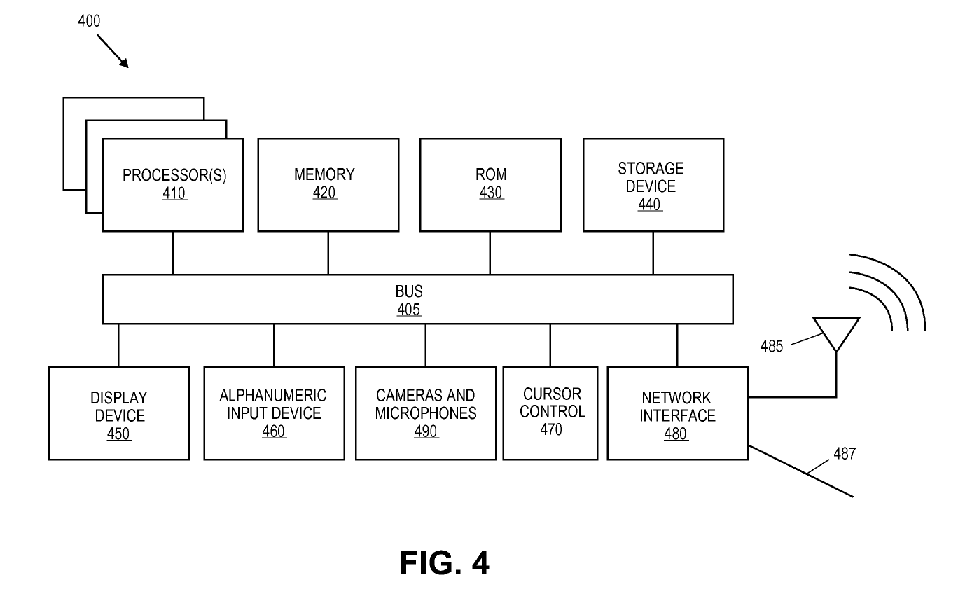

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include host machine 100 employing zone mechanism 110 of FIG. 1 and/or entity-managed server computing device 260 employing entity-based zone mechanism 262 of FIG. 2.

Computing system 400 includes bus 405 (or a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Some embodiments pertain to a method comprising: receiving, at a server computing device, a request to locate a destination relating to an entity; retrieving a first data relating to an outdoor navigation portion of an address relating to the destination; retrieving a second data relating to an indoor navigation portion of the address relating to the destination, wherein the first and second data are retrieved from a first database coupled with the first server computing device; and communicating the first data and the second data to a client computing device.

Embodiments or examples include any of the above methods further comprising evaluating the request, wherein evaluation of the request comprises translating coordinates into the address relating to the destination, wherein the coordinates include one or more of longitude coordinates, latitude coordinates, and altitude coordinates.

Embodiments or examples include any of the above methods further comprising registering the entity in response to a registration request received at the reception/authentication logic from an entity-managed server computing device associated with the entity.

Embodiments or examples include any of the above methods further comprising facilitating the entity-managed server computing device associated with the entity to retrieve the second data from a second database coupled to the entity-managed server computing device.

Embodiments or examples include any of the above methods further comprising: updating, in real-time, navigation data stored at the first database, the navigation data having the first and second data, wherein real-time updating is performed in response to update communications received from one or more sources, wherein the one or more sources include individuals, entity staff, private schedules or calendars, public schedules or calendars, and news sources; and facilitating advertisement of the entity at the client computing device, wherein the advertisement includes information relating to locations of a plurality of destinations associated with the entity.

Some embodiments pertain to a method comprising: receiving a request from a client computing device to locate a destination relating to an entity; and retrieving, from a local database, indoor navigation data relating to an address associated with the destination, wherein the registration/communication logic is further to communicate the indoor navigation data to the client computing device.

Embodiments or examples include any of the above methods further comprising facilitating registration of the entity with a server computing device, wherein, upon completion of the registration, the registration/communication logic to facilitate the server computing device to retrieve, from a remote database, outdoor navigation data relating to the address associated with the destination and provide the outdoor navigation data to the client computing device.

Embodiments or examples include any of the above methods further comprising: updating, in real-time, navigation data at the local database in response to update communications received from one or more sources, wherein the one or more sources include individuals, entity staff, private schedules or calendars, public schedules or calendars, and news sources; and facilitating advertisement of the entity at the client computing device, wherein the advertisement includes information relating to locations of a plurality of destinations associated with the entity.

Another embodiment or example incudes an apparatus to carry out operations according to any of the methods mentioned above.

In another embodiment or example, an apparatus comprises means for carrying out operations according to any of the methods mentioned above.

In one embodiment or example, a system comprises a mechanism to carry out operations according to any of the methods mentioned above.

In yet another embodiment or example, a computing device arranged to carry out operations according to any of the methods mentioned above.

In yet another embodiment or example, a communications device arranged to carry out operations according to any of the methods mentioned above.

In yet another embodiment or example, at least one machine-readable storage medium comprising a plurality of instructions that in response to being executed on a computing device, causes the computing device to carry out operations according to any of the methods mentioned above.

In yet another embodiment or example, at least one non-transitory or tangible machine-readable storage medium comprising a plurality of instructions that in response to being executed on a computing device, causes the computing device to carry out operations according to any of the methods mentioned above.

Some embodiments pertain to an apparatus comprising: reception/authentication logic to receive a request to locate a destination relating to an entity; global resource locator logic to retrieve a first data relating to an outdoor navigation portion of an address relating to the destination; local resource locator module to retrieve a second data relating to an indoor navigation portion of the address relating to the destination, wherein the first and second data are retrieved from a first database; and communication/compatibility logic to communicate the first data and the second data to a client computing device.

Embodiments or examples include the above apparatus further comprising evaluation logic to evaluate the request, wherein evaluation of the request comprises translating coordinates into the address relating to the destination, wherein the coordinates include one or more of longitude coordinates, latitude coordinates, and altitude coordinates.

Embodiments or examples include the above apparatus further comprising registry logic including registration module to register the entity in response to a registration request received at the reception/authentication logic from an entity-managed server computing device associated with the entity.

Embodiments or examples include the above apparatus wherein the local resource locator module of the registry logic to facilitate the entity-managed server computing device associated with the entity to retrieve the second data from a second database coupled to the entity-managed server computing device.

Embodiments or examples include the above apparatus further comprising: real-time resource update module to update, in real-time, navigation data stored at the first database, the navigation data having the first and second data, wherein real-time updating is performed in response to update communications received from one or more sources, wherein the one or more sources include individuals, entity staff, private schedules or calendars, public schedules or calendars, and news sources; and advertisement module to facilitate advertisement of the entity at the client computing device, wherein the advertisement includes information relating to locations of a plurality of destinations associated with the entity.

Some embodiments pertain to a computing device comprising: entity registration/communication logic to receive a request from a client computing device to locate a destination relating to an entity; and entity resource locator logic to retrieve, from a local database, indoor navigation data relating to an address associated with the destination, wherein the registration/communication logic is further to communicate the indoor navigation data to the client computing device.

Embodiments or examples include the above apparatus wherein the entity registration/communication logic is further to facilitate registration of the entity with a server computing device, wherein, upon completion of the registration, the registration/communication logic to facilitate the server computing device to retrieve, from a remote database, outdoor navigation data relating to the address associated with the destination and provide the outdoor navigation data to the client computing device.

Embodiments or examples include the above apparatus further comprising: entity real-time resource update logic to update, in real-time, navigation data at the local database in response to update communications received from one or more sources, wherein the one or more sources include individuals, entity staff, private schedules or calendars, public schedules or calendars, and news sources; and entity advertisement logic to facilitate advertisement of the entity at the client computing device, wherein the advertisement includes information relating to locations of a plurality of destinations associated with the entity.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1.-25. (canceled)

26. An apparatus comprising:
reception/authentication logic to receive a request to locate a destination relating to an entity;
global resource locator logic to retrieve a first data relating to an outdoor navigation portion of an address relating to the destination;
local resource locator module to retrieve a second data relating to an indoor navigation portion of the address relating to the destination, wherein the first and second data are retrieved from a first database; and
communication/compatibility logic to communicate the first data and the second data to a client computing device.

27. The apparatus of claim 26, further comprising evaluation logic to evaluate the request, wherein evaluation of the request comprises translating coordinates into the address relating to the destination, wherein the coordinates include one or more of longitude coordinates, latitude coordinates, and altitude coordinates.

28. The apparatus of claim 26, further comprising registry logic including registration module to register the entity in response to a registration request received at the reception/authentication logic from an entity-managed server computing device associated with the entity.

29. The apparatus of claim 28, wherein the local resource locator module of the registry logic to facilitate the entity-managed server computing device associated with the entity to retrieve the second data from a second database coupled to the entity-managed server computing device.

30. The apparatus of claim 26, further comprising real-time resource update module to update, in real-time, navigation data stored at the first database, the navigation data having the first and second data,

31. The apparatus of claim 30, wherein real-time updating is performed in response to update communications received from one or more sources, wherein the one or more sources include individuals, entity staff, private schedules or calendars, public schedules or calendars, and news sources.

32. The apparatus of claim 26, further comprising advertisement module to facilitate advertisement of the entity at the client computing device, wherein the advertisement includes information relating to locations of a plurality of destinations associated with the entity.

33. An apparatus comprising:
entity registration/communication logic to receive a request from a client computing device to locate a destination relating to an entity; and
entity resource locator logic to retrieve, from a local database, indoor navigation data relating to an address associated with the destination, wherein the registration/communication logic is further to communicate the indoor navigation data to the client computing device.

34. The apparatus of claim 33, wherein the entity registration/communication logic is further to facilitate registration of the entity with a server computing device, wherein, upon completion of the registration, the registration/communication logic to facilitate the server computing device to retrieve, from a remote database, outdoor navigation data relating to the address associated with the destination and provide the outdoor navigation data to the client computing device.

35. The apparatus of claim 33, further comprising entity real-time resource update logic to update, in real-time, navigation data at the local database in response to update communications received from one or more sources, wherein the one or more sources include individuals, entity staff, private schedules or calendars, public schedules or calendars, and news sources.

36. The apparatus of claim 33, further comprising entity advertisement logic to facilitate advertisement of the entity at the client computing device, wherein the advertisement includes information relating to locations of a plurality of destinations associated with the entity.

37. A method comprising:
receiving, at a server computing device, a request to locate a destination relating to an entity;
retrieving a first data relating to an outdoor navigation portion of an address relating to the destination;
retrieving a second data relating to an indoor navigation portion of the address relating to the destination, wherein the first and second data are retrieved from a first database coupled with the first server computing device; and
communicating the first data and the second data to a client computing device.

38. The method of claim 37, further comprising evaluating the request, wherein evaluation of the request comprises translating coordinates into the address relating to the destination, wherein the coordinates include one or more of longitude coordinates, latitude coordinates, and altitude coordinates.

39. The method of claim 37, further comprising registering the entity in response to a registration request received at the reception/authentication logic from an entity-managed server computing device associated with the entity.

40. The method of claim 39, further comprising facilitating the entity-managed server computing device associated with the entity to retrieve the second data from a second database coupled to the entity-managed server computing device.

41. The method of claim 37, further comprising updating, in real-time, navigation data stored at the first database, the navigation data having the first and second data.

42. The method of claim 41, wherein real-time updating is performed in response to update communications received from one or more sources, wherein the one or more sources include individuals, entity staff, private schedules or calendars, public schedules or calendars, and news sources.

43. The method of claim 37, further comprising facilitating advertisement of the entity at the client computing device, wherein the advertisement includes information relating to locations of a plurality of destinations associated with the entity.

44. At least one machine-readable medium comprising a plurality of instructions that in response to being executed on a computing device, causes the computing device to carry out one or more operations comprising:
receiving, at a server computing device, a request to locate a destination relating to an entity;
retrieving a first data relating to an outdoor navigation portion of an address relating to the destination;
retrieving a second data relating to an indoor navigation portion of the address relating to the destination, wherein the first and second data are retrieved from a first database coupled with the first server computing device; and
communicating the first data and the second data to a client computing device.

45. The machine-readable medium of claim 44, wherein the one or more operations comprise evaluating the request, wherein evaluation of the request comprises translating coordinates into the address relating to the destination, wherein the coordinates include one or more of longitude coordinates, latitude coordinates, and altitude coordinates.

46. The machine-readable medium of claim 44, wherein the one or more operations comprise evaluating registering the entity in response to a registration request received at the reception/authentication logic from an entity-managed server computing device associated with the entity.

47. The machine-readable medium of claim 46, wherein the one or more operations comprise evaluating facilitating the entity-managed server computing device associated with the entity to retrieve the second data from a second database coupled to the entity-managed server computing device.

48. The machine-readable medium of claim 44, wherein the one or more operations comprise evaluating updating, in real-time, navigation data stored at the first database, the navigation data having the first and second data.

49. The machine-readable medium of claim 48, wherein real-time updating is performed in response to update communications received from one or more sources, wherein the one or more sources include individuals, entity staff, private schedules or calendars, public schedules or calendars, and news sources.

50. The machine-readable medium of claim 44, wherein the one or more operations comprise evaluating facilitating advertisement of the entity at the client computing device, wherein the advertisement includes information relating to locations of a plurality of destinations associated with the entity.
